(19) United States
(12) Patent Application Publication
(10) Pub. No.: US 2007/0195668 A1
(43) Pub. Date: Aug. 23, 2007

(54) Apparatus and method for discrimination between optical record carriers of different formats

(75) Inventors: Jeroen Arnoldus Leonardus Johannes Raaymakers, Eindhoven (NL); Edwin Johannes Maria Janssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN, NETHERLANDS 5621 BA (NL)

(21) Appl. No.: 11/568,140

(22) PCT Filed: Apr. 11, 2005
(86) PCT No.: PCT/IB05/51183

§ 371 Date: Oct. 20, 2006

(30) Foreign Application Priority Data
Apr. 26, 2004 (EP) 04101728.6

(51) Int. Cl. G11B 7/00

(52) U.S. Cl. 369/53.2; 369/44.29

(57) ABSTRACT

Apparatus and method for discriminating in an optical drive between discs of different formats, in which the optical disc remains substantially stationary or is arranged to rotate at a very low frequency i.e. significantly lower than that required to perform a data readout or record action for the purpose of measuring the reflectivity thereof by ramping, i.e. moving, the actuator toward the optical disc (step 106a) and, during this ramp, observing (step 106b) the total reflection, known as the Central Aperture (CA), off the disc. After scaling of the reflectivity (at step 108), the system tries to catch focus (step 110) i.e. close the focus servo loop). If, at step (112), the measured reflectivity is far out of range, or the focus catch fails, then the sequence is repeated for the next laser, until the disc format has been accurately determined.

This invention relates to an optical drive of an optical storage system for reproducing, and optionally recording, optical record carriers of different formats and with laser radiation of different respective wavelengths and, more particularly, to a method and apparatus for discriminating in an optical storage system between optical carriers of different formats.

Optical data storage systems provide a means for storing large quantities of data on an optical record carrier, such as an optical disc. The data is accessed by focusing a laser beam onto the data layer of the disc and then detecting the reflected light beam. In one known system, data is permanently embedded as marks, such as pits, in the disc, and the data is detected as a change in reflectivity as the laser beam passes over the marks.

The optical disc storage technology that employs an optical disc with pit patterns as a high-density, large-capacity recording medium has been put into practical use while expanding its applications to digital versatile discs (DVDs), and Blu-ray discs (BD), having both single and multi-layer and read-only and recordable variants.

In all cases, to read out or record data, it is necessary to position an optical spot onto the disc track. The position of the readout spot is determined by the position of an objective lens provided for this purpose. Positioning of the readout spot and, therefore, the objective lens should be done in two directions: in focus (from and towards the disc) and in a radial direction. This is achieved by moving the objective lens. Thus, the objective lens is mounted in an actuator, and control of the actuator is therefore used to perform focus and radial positioning of the optical spot. However, the stroke of the actuator is limited and, for radial positioning control, a large stroke is needed. Therefore, in conventional systems, the complete actuator is mounted on a sledge, which is also controlled in a radial direction over a large stroke. It will be appreciated that the sledge is also known as the optical pickup unit (OPU), and the laser and photodetector are also typically mounted on the OPU. Sledge control is typically effected using a sledge stepper motor.

In order to improve the recording density of an optical disc, an increase in the numerical aperture (NA) of the objective lens is used. Thus, the respective NA of the objective lens for each one of a number of different record carrier formats will be different.

A desirable property for an optical scanning device is compatibility, i.e. the ability to reproduce and (in some cases) record optical record carriers of different formats. Compact discs (CD's) are available, inter alia, as CD (CD-Audio), CD-ROMs (CD-Read Only Memory), CD-Rs (CD-Recordable) and cd-RWs (CD Rewritable). CD's are designed to be scanned with laser radiation having a wavelength of around 780 nm and a numerical aperture (NA) of 0.45. DVD's (Digital Versatile Discs), on the other hand, are designed to be scanned at a wavelength in the region of 660 nm. In order to read DVDs, a NA of 0.6 is generally used, whereas for writing DVDs, a NA of 0.65 is generally required.

Nevertheless, DVD-drives are known which can also read out CD's. For example, WO99/57720 describes a system which is capable of reading DVD and CD by using laser radiation of different wavelengths with the same objective lens. The objective lens comprises a moulded plastic lens having either two refractive aspheric surfaces or one aspherical surface and one refractive spherical surface including a diffractive element. The lens is capable of correcting for spherical aberration caused by the difference in thickness for the two disc formats, as well as for chromatic aberration.

In order to achieve multi-format compatibility in an optical storage system, it is necessary to provide some means for discriminating between the disc formats, such that the correct laser wavelength is selected and scaling of the front-gains is correctly performed. There are several known disc discrimination methods used in conventional drives. For example, some drives simply start with the laser used for the previous disc and then ramp towards a rotating disc to measure the reflectivity. After scaling of the reflectivity (by changing the front gain), the system tries to catch focus, i.e. close the focus servo loop. If the reflectivity is far out of range, or the focus catch fails, then the sequence is repeated for the next laser.

The above-mentioned reflectivity measurement is performed by ramping, i.e. moving the actuator toward the disc. During this ramp, the total reflection, called the central aperture (CA), is observed. Generally, two peaks in CA are observed. The first one originates from the pre-reflection of the substrate, and the second one originates from the data layer. The amplitude of the second peak in CA is measured. The result is used to adjust the front-gain of the pre-amplifiers such that the input range of the DAC's in the digital controller is fully used.

In order to average the result of the reflection measurement over the disc, the disc is rotated at an intermediate speed (typically 20-40 Hz). By rotating the disc, the surface on which the measurement is performed is effectively larger than the readout spot. As a consequence, the measure is less sensitive to local disturbances (e.g. black-dots and fingerprints), which affect the reflectivity.

Following the introduction of CD and DVD disc formats, multi-layer variants of DVD discs and multi-layer high capacity variants such as Blu-ray Disc (BD) has been introduced, and it is obviously desirable to provide an optical scanning device which can not only read out CD and DVD, for example, but also discs of other formats, such as the above-mentioned dual layer and BD variants. These three formats operate at the wavelengths of typically 405 nm, 655 nm and 785 nm, at numerical aperture (NA) values of typically 0.85, 0.60-0.65 and 0.45-0.55, and with cover thicknesses of 75 and 100 Φ m (the two depths of the BD system), 600 Φ m and 1200 Φ m, respectively.

However, these different disc formats make disc recognition more and more difficult. As explained above, for each disc format, a different laser is required. Besides that, there is a large difference in reflectivity between discs within each family, say ROM, RW or R. It will be apparent from the above that the first aspect of disc recognition is the selection of the proper laser and the scaling of the front-gains. However, the reflection measurement described above can cause problems under some circumstances, as will now be explained.

The above-mentioned reflection measurement is typically performed on an unknown rotating disc and, as a consequence, the measurement can, initially, be performed with the wrong laser. The ramp (by the actuator) toward the disc is primarily only stopped after the system finds a proper peak in reflection. In CD and DVD systems, the free working distance (where “free working distance” or fwd is the distance between the focus actuator and the disc when the system is brought into focus) is approximately 1 mm. Therefore, it is relatively easy for the drive to stop before the actuator hits the disc. In addition, if for some reason no peak in CA is detected, the ramp toward the disc can easily be stopped before an actual collision between the actuator and the disc occurs. However, in optical drives having a relatively small free working distance, the ramp proceeds very close to the disc, and collisions between the actuator and the disc can no longer be avoided. For example, for BD-compatible light-paths (i.e both BD only systems or those compatible with BD and other (e.g. conventional) disc formats), the free working distance is typically only 0.1-0.2 mm. Furthermore, while the disc rotates, its surface wobbles (in a vertical direction) so that the distance between the focus actuator and the disc can vary unpredictably during operation. As a result of collisions between the actuator and the disc, scratches, and particularly concentric scratches, can occur, as can damage to the focus actuator and/or objective lens, which is obviously highly undesirable.

In another known arrangement, the system can differentiate between discs of different formats by measuring the thickness between substrate reflection and a data layer of the disc. However, in this case also, collisions between the actuator and the disc can occur for the same reasons as are explained in detail above.

We have now devised an improved arrangement, and it is an object of the present invention to provide a method and apparatus for discriminating in an optical storage system between optical record carriers of different formats. It is also an object of the invention, to provide an optical drive and an optical storage storage system including such apparatus.

Thus, in accordance with the present invention, there is provided apparatus for discriminating in an optical storage system between optical record carriers of different formats, the optical storage system comprising means (16) for rotating an optical record carrier (8) loaded therein at a speed suitable for reproducing and/or recording said optical record carrier, means for focusing a beam of radiation on said optical record carrier (8), and an actuator for moving said focusing means relative to said optical record carrier (8), the apparatus comprising means for measuring a parameter of an optical record carrier (8) loaded in said optical scanning device, said parameter relating to the form of said optical record carrier (8), said actuator being moved toward said optical record carrier (8) for the purpose of measuring said parameter thereof, wherein the speed of rotation of said optical record carrier (8) is substantially zero or at least significantly lower than the speed of rotation required for reproducing and/or recording said optical record carrier (8), for the purpose of measuring the parameter thereof.

Also in accordance with the present invention, there is provided a method of discriminating in an optical storage system between optical record carriers of different formats, the optical storage system comprising means (16) for rotating an optical record carrier (8) loaded therein at a speed suitable for reproducing and/or recording said optical record carrier (8), means for focusing a beam of radiation on said optical record carrier (8), and an actuator for moving said focusing means relative to said optical record carrier (8), the method comprising measuring a parameter of an optical record carrier (8) loaded in said optical scanning device, said parameter relating to the format of said optical record carrier (8), said actuator being moved toward said optical record carrier for the purpose of measuring said parameter thereof, wherein the speed of rotation of said optical record carrier (8) is substantially zero or at least significantly lower than the speed of rotation required for reproducing and/or recording said optical record carrier, for the purpose of measuring the parameter thereof.

The present invention also extends to an optical storage drive incorporating the apparatus or method defined above.

The parameter may comprise reflectivity of the optical record carrier or the distance between the surface of said optical record carrier and a data layer thereof.

The means for measuring reflectivity preferably comprises means for measuring the amplitude of, and/or identifying peaks in, the central aperture (CA) of the optical record carrier. In a more preferred embodiment, means are provided for measuring the distance (or time) between two peaks in central aperture (CA) measured during movement of said actuator toward said optical record carrier.

It will be appreciated by a person skilled in the art that a first peak in CA may occur at the entrance surface (or substrate) of the optical record carrier, and a second peak at a first data layer (CO). With a known distance (or time which can then be multiplied by the known ramp speed of the actuator) the disc type can be determined.

The optical storage system may further comprise an optical pickup unit or sledge, and means, such as a sledge stepper motor, for moving said optical pickup unit relative to said optical record carrier. In addition to reducing the speed of rotation, or substantially stopping rotation altogether, of the optical record carrier for the purpose of measuring the reflectivity thereof, the apparatus may also be arranged to effect movement, most preferably, substantially radial movement, of the actuator and/or the optical pickup unit, relative to the optical record carrier.

In effect, the present invention is preferably arranged to identify peaks in CA, preferably by measuring the amplitude thereof. In the case of a black dot, scratch or other artifact the measured CA does not correspond to the reflection of the disc, so measuring in a disc artifact should be avoided. In prior art arrangements, because the disc is rotating, during the measurement of CA the disc moves over the spot (or spot moves over the disc), which on its turns results in an averaging operation, which is advantageous.

In the case of the present invention, because the measurement is performed on a non-rotating disc (or a disc which is rotating very slowly), the arrangement generally will become more sensitive to disc artifacts, e.g. suppose the ramping happens to occur into a black dot (although the chance of this is small, of course), the negative side-effect that would otherwise occur as a result is offset by the radial “wobble” of the actuator or sledge, which moves the spot in radial direction over the non rotation disc. So, to summarize, the disc is not rotated (or rotated very slowly) during the reflectivity measurement so as to improve robustness against the occurrence of scratches. However, as a result, only the peak in CA is measured on a very limited part of the disc, so averaging is limited. This disadvantage is offset by the radial wobble.

These and other aspects of the present invention will be apparent from, and elucidated with reference to, the embodiment described herein.

An embodiment of the present invention will now be described by way of example only and with reference to the accompanying drawings, in which:

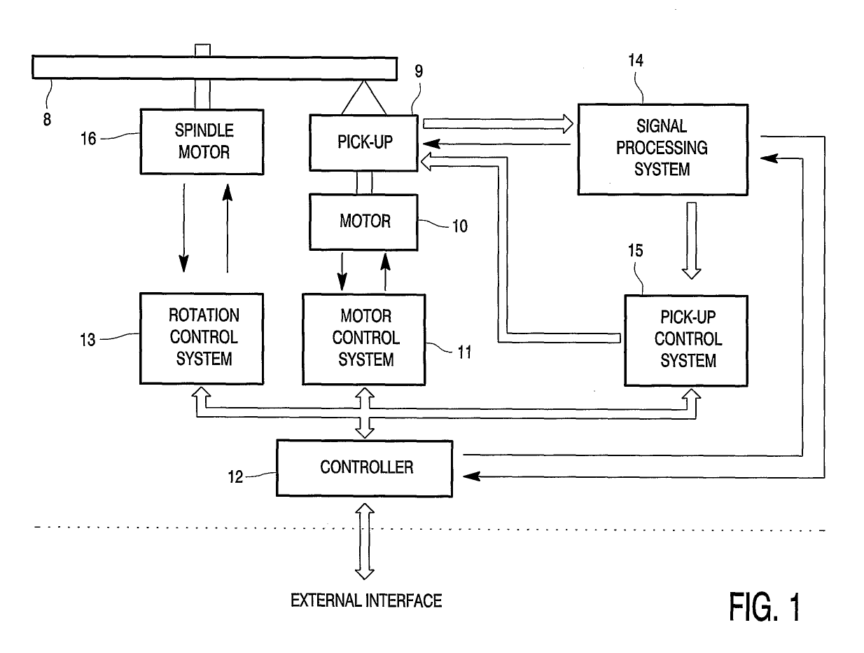

FIG. 1 is a schematic block diagram of a typical optical information recording apparatus; and

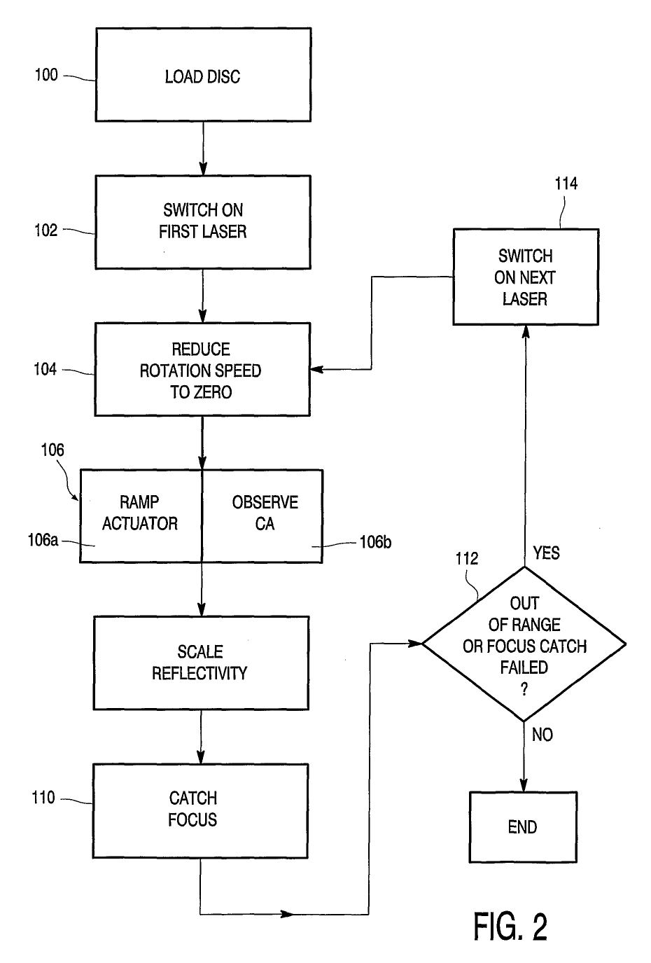

FIG. 2 is a schematic flow diagram illustrating a method of discriminating in an optical storage system between optical record carriers of different formats according to an exemplary embodiment of the present invention.

Thus, as explained above, systems for discriminating in an optical scanning device between optical record carriers (or optical discs) of different formats exist. U.S. Pat. No. 5,966,357 describes an optical storage system which can discriminate as to whether a CD or DVD is loaded therein, by detecting light reflected from the loaded disc using a plurality of optical detectors, calculating a sum signal and a focus error signal from the signals detected using the above-mentioned plurality of optical detectors, comparing the sum signal with a first reference value and the focus error signal with a second reference value to determine a comparison result, from which the system can determine the format of the loaded disc (i.e. CD or DVD).

The above-mentioned reflection measurement is typically performed on an unknown rotating disc and, as a consequence, the measurement can, initially, be performed with the wrong laser. More importantly, the axial movement (or ramp) by the optical pickup unit (incorporating the actuator) toward the disc is only stopped after the system determines the loaded disc type or a predetermined number of attempts to perform such discrimination have been made. In CD and DVD systems (as described in U.S. Pat. No. 5,966,357), the free working distance is approximately 1 mm. Therefore, it is relatively easy for the drive to stop before the actuator hits the disc. In addition, if for some reason the disc discrimination process fails, the ramp toward the disc can easily be stopped before an actual collision between the actuator and the disc occurs.

However, in optical drives having a relatively small free working distance, the ramp proceeds very close to the disc, and collisions between the actuator and the disc can no longer be avoided. For example, for BD-compatible light-paths (i.e both BD only systems or those compatible with BD and other (e.g. conventional) disc formats), the free working distance is typically only 0.1-0.2 mm. As a result of collisions between the actuator and the disc, scratches, and particularly concentric scratches, as well as focus actuator and/or objective lens damage, can occur.

U.S. Pat. No. 6,510,115 describes an optical storage system in which disc discrimination is again performed to determine if the loaded optical disc is a CD or DVD using the intensity of light reflected from the disc, and then the appropriate laser for readout or recordal of data is selected based on the result. In order to perform this disc discrimination method, the disc in question is first loaded and then rotated at a predetermined minimum speed. The disc is irradiated by a laser, the amplitude of the reflected light collected by a suitably positioned optical detector is determined. Next, the objective lens is moved (by movement of the actuator) relative to the optical disc, and a focus error signal is determined and compared against a reference, to determine the format of the loaded disc. Damage to the disc, and accidental recordal of data during the disc discrimination process, is prevented by ensuring that the disc is rotated at a speed greater than 5 Hz and by controlling the power at which lasers of certain wavelengths are caused to irradiate the disc.

Once again, however, the arrangement described in U.S. Pat. No. 6,510,115 relates only to the discrimination between CD and DVD disc formats, in which there is a relatively large free working distance to allow for the axial movement of the actuator relative to the disc, without the significant risk of collisions between the actuator and the disc causing damage to either or both. However, as explained above, in optical drives having a relatively small free working distance, the ramp proceeds very close to the disc, and collisions between the actuator and the disc can no longer be avoided. For example, for BD-compatible light-paths (i.e both BD only systems or those compatible with BD and other (e.g. conventional) disc formats), the free working distance is typically only 0.1-0.2 mm. As a result, collisions can occur between the actuator and the disc, and scratches, particularly concentric scratches occur, as can damage to the focus actuator and/or objective lens, which is obviously highly undesirable.

It is therefore an object of the present invention to provide an optical storage system which is capable of discriminating between optical record carriers of different respective formats with little or no risk of damage to the record carrier or the actuator caused by collisions therebetween, irrespective of the free working distance available. To summarise, in order to achieve this object, the present invention provides an arrangement in which the disc discrimination process is performed (by measuring the reflectivity of the record carrier loaded therein) while the loaded disc is substantially at a standstill or rotating at a speed significantly lower than that required for the purposes of data readout or recordal (so that the disc hardly wobbles. As a result, measure-means of reflection (or distance between the substrate surface and a data layer of the optical record carrier) can be performed without disc and or actuator/objective lens damage. Since the optical record carrier is not rotating (or barely rotating), it is not possible to average the CA over the disc, as in the prior art. In order to counteract this, and make the measurements less sensitive to local disturbances, the actuator and/or optical pickup unit (OPU) may be arranged to move in a radial direction (or “wobble”) relative to the loaded record carrier during performance of the disc discrimination process, as will be described in more detail below.

Referring in the first instance to FIG. 1 of the drawings, optical information recording apparatus typically comprises an optical disc drive unit comprising an optical pickup unit (OPU) 9 for recording information to, or reading information from, an optical disc 8. Within the OPU 9, and as explained above, there is provided an objective lens mounted in an actuator for performing focus and (fine) radial control of the optical readout spot. Also provided in the OPU 9 is a laser and a photo detector for detecting radiation reflected back from the optical disc 8. The OPU 9 is connected to a sledge stepper motor 10 for performing (course) radial control of the OPU 9 relative to the optical disc 8, and the motor 10 is connected to a controller 12 via a motor control system 11. The controller 12 is connected to a rotation control system 13, a signal processing system 14, and a pickup control system 15. The rotation control system 13 is connected to a spindle motor 16 so as to rotate the optical disc 8, and the signal processing system 14 and the pickup control system 15 are connected to the optical pickup unit 9 so as to perform a recording or reproducing operation and a servo control operation (focusing, tracking) of the OPU 9.

In use, and referring additionally to FIG. 2 of the drawings, the optical disc 8 is loaded (at step 100) and a first laser is switched on (at step 102). This may simply be the laser which was in use in respect of a previous disc loaded in the system, or there may be a predetermined order in which each of the lasers provided for the respective disc formats for which the system is compatible are employed for the disc discrimination process.

Preferably, the optical disc 8 remains substantially stationary (or, if applicable, its speed is reduced to substantially zero at step 104), although the system may be arranged to rotate the optical disc 8 at, or reduce its speed of rotation to, a very low frequency, i.e. significantly lower than that required to perform a data readout or record action.

Next, the reflectivity of the optical disc 8 is measured (step 106) by ramping, i.e. moving, the actuator toward the optical disc 8 (step 106a) and, during this ramp, observing (step 106b) the total reflection, known as the Central Aperture (CA), of the disc. Generally, two peaks in CA are observed. The first one originates from the pre-reflection of the substrate and the second one originates from the data layer. The amplitude of the second peak in CA is measured and the result is used to scale the reflectivity by changing the front-gain of the pre-amplifiers such that the input range of the DACs in the digital controller are fully used.

After scaling of the reflectivity, the system tries to catch focus (step 110), i.e. close the focus servo loop). If, at the “scale reflectivity” step, the measured reflectivity is determined to be far out of range, or the focus catch fails, then the process jumps to “switch on next laser” (step 114) and the above-mentioned sequence is repeated for the next laser, until the disc format has been accurately determined.

In order to average the result of the reflection measurement over the disc, so as to average out possible disc artifacts and make the measure less sensitive to local disturbances which would affect the reflectivity, such as black-dots and fingerprints, it is proposed to wobble the actuator and/or the optical pickup unit, i.e. move it/them in a radial direction relative to the optical disc.

It will be appreciated that the “start-up” procedure described above with reference to FIG. 2, is given by way of example only, and other procedures exist to which the present invention is equally applicable.

The following advantageous combinations of features are specific exemplary embodiments of the present invention:
a) make the rotation of the disc very slow during ramping (so that the disc hardly wobbles), with no radial movement of the optical pickup unit or the actuator;
b) make the rotation of the disc very slow during the ramping process and also apply radial movement of the optical pickup unit and/or the actuator relative to the optical disc;
c) do not rotate the optical disc at all during the ramping, with no radial movement of the optical pickup unit or the actuator;
d) do not rotate the optical disc at all during ramping and also apply radial movement of the optical pickup unit and/or the actuator relative to the optical disc.

Options a) and d) are considered to be particularly advantageous embodiments, at least in some circumstances.

As a result of the present invention, the likelihood of a collision between the actuator and the disc is substantially eliminated and the chance of scratches occurring is very limited. Concentrical scratches, which are the worst, are substantially completely avoided.

The present invention is suitable for use in optical data storage drives which are compatible with optical record carriers of at least two different formats, particularly those having a relatively small free working distance.

An embodiment of the present invention has been described above by way of example only, and it will be apparent to a person skilled in the art that modifications and variations can be made to the described embodiment without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. Apparatus for discriminating in an optical storage system between optical record carriers of different formats, the optical storage system comprising means (16) for rotating an optical record carrier (8) loaded therein at a speed suitable for reproducing and/or recording said optical record carrier, means for focusing a beam of radiation on said optical record carrier (8), and an actuator for moving said focusing means relative to said optical record carrier (8), the apparatus comprising means for measuring a parameter of an optical record carrier (8) loaded in said optical scanning device, said parameter relating to the format of said optical record carrier (8), said actuator being moved toward said optical record carrier (8) for the purpose of measuring said parameter thereof, wherein the speed of rotation of said optical record carrier (8) is substantially zero or at least significantly lower than the speed of rotation required for reproducing and/or recording said optical record carrier (8), for the purpose of measuring the parameter thereof.

2. Apparatus according to claim 1, wherein said parameter comprises reflectivity of said optical record carrier (8).

3. Apparatus according to claim 1, wherein said parameter comprises the distance between the substrate surface and a data layer of said optical record carrier (8).

4. Apparatus according to claim 1, wherein the optical storage system further comprises an optical pickup unit (9) or sledge, and means (10) for moving said optical pickup unit (9) relative to said optical record carrier (8), wherein the apparatus is arranged to effect radial movement of the actuator and/or the optical pickup unit (9) relative to the optical record carrier (8).

5. Apparatus according to claim 1, wherein the means for measuring said parameter comprises means for observing and/or measuring the central aperture (CA) of the optical record carrier.

6. Apparatus according to claim 5, wherein the means for measuring said parameter comprises means for identifying at least one peak in the central aperture.

7. Apparatus according to claim 6, wherein the amplitude of said at least one peak is measured.

8. Apparatus according to claim 6, wherein at least two peaks in CA are identified and the distance therebetween determined.

9. Apparatus according to claim 1, wherein for the purpose of said parameter measurement, said optical record carrier (8) is substantially stationary.

10. Apparatus according to claim 9, wherein for the purpose of said parameter measurement, radial movement of said actuator and/or said optical pickup unit (9) relative to said optical record carrier is effected.

11. Apparatus according to claim 1, wherein for the purpose of said parameter measurement, the optical carrier (8) is rotated at a speed significantly lower than that required for data readout or record actions, such that any vertical movement of the surface of said optical record carrier has an insignificant effect on said parameter measurement.

12. Apparatus according to claim 11, wherein for the purpose of said parameter measurement, radial movement of said actuator and/or said optical pickup unit (9) relative to said optical record carrier (8) is effected.

13. A method of discriminating in an optical storage system between optical record carriers of different formats, the optical storage system comprising means (16) for rotating an optical record carrier (8) loaded therein at a speed suitable for reproducing and/or recording said optical record carrier (8), means for focusing a beam of radiation on said optical record carrier (8), and an actuator for moving said focusing means relative to said optical record carrier (8), the method comprising measuring a parameter of an optical record carrier (8) loaded in said optical scanning device, said parameter relating to the format of said optical record carrier (8), said actuator being moved toward said optical record carrier for the purpose of measuring said parameter thereof, wherein the speed of rotation of said optical record carrier (8) is substantially zero or at least significantly lower than the speed of rotation required for reproducing and/or recording said optical record carrier, for the purpose of measuring the parameter thereof.

14. An optical drive incorporating apparatus according to claim 1.
